(19) United States
(12) Patent Application Publication
(10) Pub. No.: US 2008/0052002 A1
(43) Pub. Date: Feb. 28, 2008

(54) Wave and tide monitoring and recording system

(75) Inventors: Luis Manoel Paiva Nunes, Barra da Tijuca (BR); Leonardo Brantes Bacellar Mendes, Jardim Botanico (BR); Diorgenes Penteado, Tijuca (BR)

Correspondence Address: NIXON & VANDERHYE, PC, 901 NORTH GLEBE ROAD, 11TH FLOOR, ARLINGTON, VA, 22203, US

(73) Assignee: PETROLEO BRASILEIRO S.A. - PETROBRAS, Rio de Janeiro (BR)

(21) Appl. No.: 11/896,488

(22) Filed: Aug. 31, 2007

(30) Foreign Application Priority Data
Mar. 3, 2006 (BR) 0600797-0

(51) Int. Cl. G01D 21/00

(52) U.S. Cl. 702/2; 73/170.31

(57) ABSTRACT

A system to monitor and record wave and tides, based on using equipment to monitor and record tides and the characteristics of ocean wave size and period, by indirectly measuring changes in the level of water around a pipe, the upper end of which is hermetically sealed and the lower end of which is submerged in the ocean, and its correlation to the measurement of the corresponding change in pressure inside the pipe. The system may be used to continually record changes in the ocean surface, to obtain the level of tides and the characteristics of its waves.

### CROSS REFERENCE TO RELATED APPLICATION

This application is based upon and incorporates by reference, the contents of Brazilian Patent Application No. PI 0600797-0 filed Mar. 3, 2006.

### FIELD OF THE INVENTION

This invention refers to a wave and tide monitoring system that indirectly monitors variations in the water level around a tube that is hermetically sealed on the upper end and submerged in a liquid medium. The method used for measurement is based on the pressure variation occurring inside the pipe submerged in a liquid medium as a consequence of the height variations of the water column surrounding it. More in particular, this invention refers to equipment and a method for monitoring and recording the characteristics of tides and ocean wave size and period, which permits changes in waves and tides to be recorded and followed in a simple, economical and secure manner.

### BACKGROUND OF THE INVENTION

Environmental conditions constitute a critical issue in oil exploration, so in order for the equipment to act with precision and security on a floating unit, prior oceanographic studies must be performed by gathering “in situ” data. Ocean operations are complex and demand that logistics be planned in advance in order to avoid a needless rise in costs. Therefore, it is necessary to determine, as precisely as possible, whether or not ocean conditions will be favorable, so that operational planning may be successfully carried out. In this context, the measurement of waves and tides become of fundamental importance. Sophisticated systems have been developed to monitor ocean waves and tides; some seek to predict the occurrence of elevated values in these oceanographic parameters in order to support the professionals that work on the ocean. The purpose of this invention is to present a simple, low cost, secure system that meets the immediate needs of those that work and depend upon the ocean, to support, for example, naval construction projects and the exploitation of offshore petroleum operations.

Techniques using several types of equipment developed for similar objectives to this invention are known in the field. Even so, such equipment uses sophisticated measuring methods, which if applied, greatly increase operational costs, besides presenting some disadvantages which shall be discussed below.

Buoys are frequently used equipped with very sophisticated measuring instruments that measure the vertical and horizontal acceleration of the waves. Afterwards, the signals measured are properly processed to obtain the displacement values recorded. However, these devices have the disadvantage of requiring anchorage, besides being very expensive and subject to acts of vandalism. The documentation of patents EP 1262792 and JP 2005083998 describes this type of equipment.

Pressure sensors that work under water are equally well known in the field. The passage of the wave alters the pressure recorded by the equipment, accompanied by their variations. One disadvantage of this type of equipment is that it needs constant maintenance because of biological incrustations, which alter the features of the equipment, and divers are depended upon to perform its maintenance. The documents of patents GB 2379741 and JP 2000161955 may be cited as an example.

Radar actuated instruments are widely applied. Wave characteristics are obtained by the difference between the frequencies emitted and received (Doppler) and by the intensity of the echo. However, this indirect measurement is less precise, is very costly and does not permit the attainment of a temporary series of data, because it only functions within the domain of frequencies. Patent JP 8292273 may be cited as an example.

Resistive staffs (as they are called) may also be used, which are electric circuits in which one of their features, such as electric resistance, is altered by variations in the level of the sea. This type of equipment is not very durable and needs constant maintenance against incrustations. The documentation of the patent JP 2001027572 describes this type of equipment.

Some equipment performs measurement by using the Doppler Effect from an inverted acoustic transmitter (Acoustic Doppler Current Profilers—ADCP). Nevertheless, their cost is just as high, divers must be employed to perform maintenance and are subject to incrustations. The documentation of patent JP 62247278 describes this type of equipment.

Other devices use laser to perform their measurements; alterations in sea level are examined by reflecting the signal on the surface of the ocean. The main disadvantage of these devices is that the signal undergoes changes due to the splashing of the waves.

### SUMMARY OF THE INVENTION

This invention refers to an ocean wave and tide monitoring and recording system, based on the use of equipment to monitor and record tides and the characteristics of the ocean wave size and period, by indirectly measuring variations in the level of water around a tube hermetically sealed at its upper end and having the lower end submerged in the sea, and its correlation to the measurement of the corresponding change in pressure within the tube. The invention also deals with the method of use of the referenced equipment.

This invention may be used for continuous recording of the elevation of the ocean surface, to obtain the level of tides and the characteristics of the ocean waves.

### BRIEF DESCRIPTION OF THE DRAWINGS

These and other objects and advantages of this invention will be more completely understood and appreciated by careful study of the following more detailed description of the presently preferred example embodiments of the invention taken in conjunction with the accompanying drawings, in which:

FIG. 1 is a schematic drawing illustrating the principle upon which the equipment of the invention is based; and

FIG. 2 is a schematic drawing of the system of the invention.

### DETAILED DESCRIPTION OF THE INVENTION

In order to facilitate the understanding of the invention, its description shall be made in a detailed manner together with the figures that accompany this report and are an integral part of same.

The system of this invention is based on the principle of physics which states that the pressure within a liquid is constant at the same depths and corresponds to the pressure of the surface increased by the product of the density of the liquid (d) by the acceleration of gravity (g) and by the height of the column of liquid (h) above the point up to the surface.

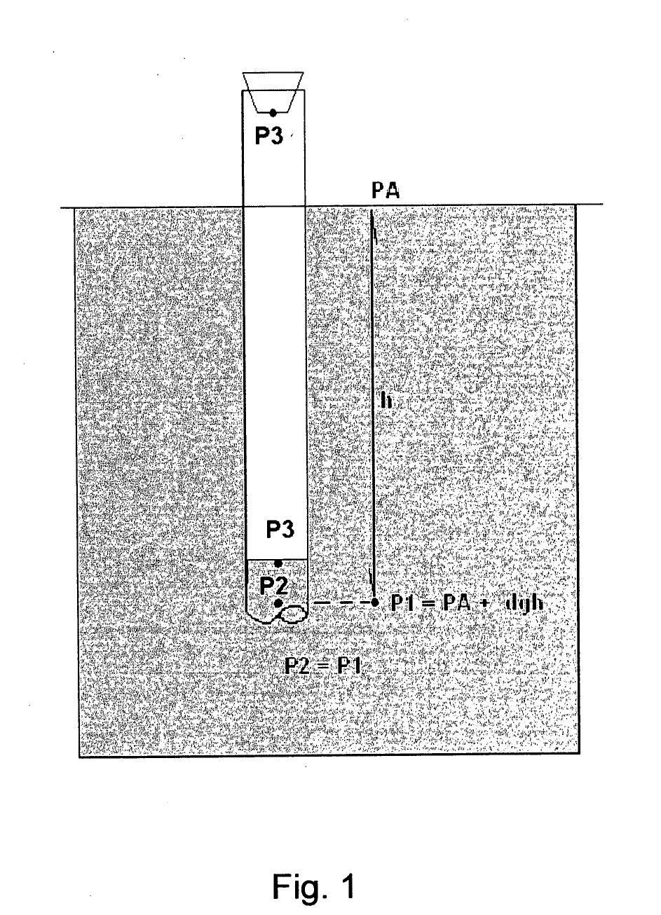

As illustrated in FIG. 1, the pressure (P1) measured at the lower end of a tube submerged in a liquid, will be:
P1=PA+dgh
where:
PA=pressure at the surface of the liquid;
d=density of liquid;
g=acceleration of gravity;
h=height of the column of liquid above the point in question.

Since the tube is hermetically sealed at its upper end, it forms a column full of air upon being submerged into a liquid, in a vessel, in the ocean; the pressure at this point in its interior (P3) will be very close to that of its inside end (P2), submerged in liquid, as shown in FIG. 1. Thus, if there is a change in the liquid column around the tube, the variation in pressure inside the tube (P3) will be directly proportional to the height of the column of liquid around it. This correlation between the variation in pressure and the height of the liquid column will, thus, be used as the variable to be measured.

According to the principle mentioned above, a wave and tide monitoring and recording system was developed, object of this invention, which, in a simple but secure way, is proposed to solve the technical problems discussed above with the advantage of presenting a low cost.

The system described in this invention is based on using equipment for monitoring and recording the tides and the characteristics of ocean wave size and period, by indirectly measuring variations in the level of water around a tube, hermetically sealed in the upper end with the lower end submerged in the sea water, and its correlation to the measurement of the corresponding variation in pressure inside the tube.

On the other hand, when using this parameter to estimate waves and tides, it must be kept in mind that once the air contained inside the tube is heated, it can alter its internal pressure. Nevertheless, it was verified in tests performed on the prototype of the equipment that this effect is, in principle, small for the environmental conditions of the Brazilian coast. In the case of locations subject to great variations in temperature, it may be necessary to provide thermal insulation for the tube, or to correct the internal heating effect on this air by measuring simultaneously the temperature of the air, using temperature sensors installed in the equipment, for example, a thermocouple (not shown in the Figures). In this way, if necessary, the effect of the heat over the internal pressure measured may be thusly compensated for.

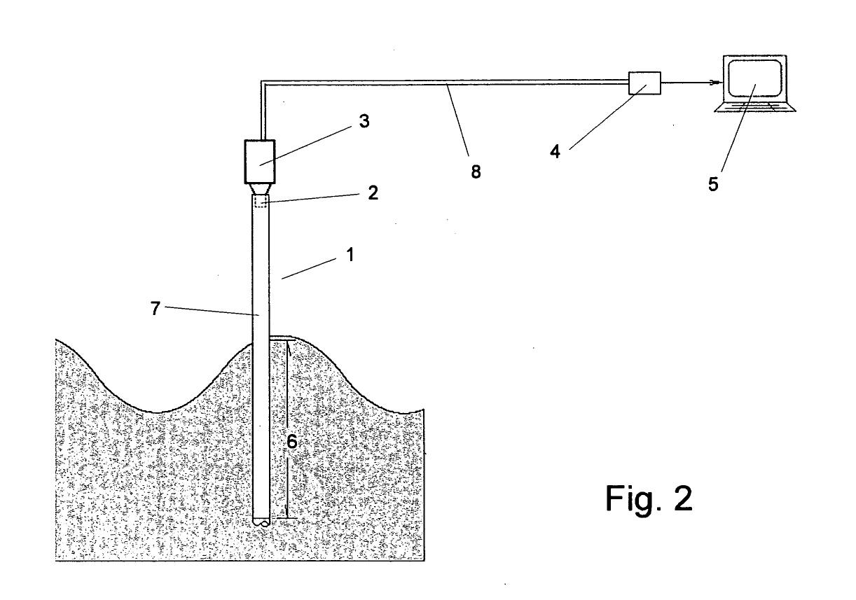

As shown in FIG. 2, the system includes a device constructed with a peculiar arrangement of the following elements: A hermetically sealed tube (1), provided with a pressure sensor (2) on its upper end with its lower end submerged in the sea; a signal conductor (3), connected to the referenced pressure sensor (2); a signal acquisition module (4); and a micro-processor (5), equipped with dedicated software, to acquire, record, and process the signals, which are converted and presented in the form of a chart.

In tests performed using the system of the invention, a pressure signal sensor (2) connected to the upper end of the tube (1) was used; the signal conductor has an electric output of 4-20 mA.

The tube (1) was connected to a structure situated in the desired location to monitor waves and tides. The system components were installed by linking them to the pressure transmitter (3), the electric signal acquisition module (4), and the micro-processor (5); the program that monitors and records the elevation of the ocean surface around the tube (1) was run.

As the level (6) of the water around the tube (1) changes, a variation is produced in the air pressure on the inside (7) of the tube, which is directly and linearly proportional to the former change. This variation in pressure is converted into an electric signal of between 4-20 mA, proportional to the pressure inside the tube. A pair of cables (8) linked to the entrance of a signal acquisition module (4) conducts the output electrical signal; the signal acquisition module (4) converts the electric signal between 4-20 mA into digital information, which is sent to a micro-processor (5) containing a dedicated software to monitor, record, and process these signals.

In the tests performed, waves were simulated to be environmental conditions around the tube as similar as possible to real waves; a deep tank was used, using vertical displacement on the same order of size as the waves. The signals collected by the system (electric signals between 4 and 20 mA) are converted into height of wave and shown on the output screen of the acquisition software in the form of a chart (height of wave versus time).

The system proposed here may be used to continually record changes in the ocean surface, to obtain the level of tides and the characteristics of its waves. In the case of locations subject to great variations in temperature, it may be necessary to provide insulation for the tube so as to avoid conduction of thermal energy, or to correct the internal heating effect on this air by measuring the air temperature simultaneously, using temperature sensors installed in the equipment.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. Wave and tide monitoring and recording system including a device constructed with a peculiar arrangement of the following elements: a hermetically sealed pipe (1) provided with a pressure sensor (2) on its upper end with its lower end submerged in the ocean; a signal transmitter (3), connected to the referenced pressure sensor (2); a signal acquisition module (4); and a micro-processor (5), equipped with dedicated software, to acquire, record, and process the signals, which are converted and presented in the form of a chart.

2. Wave and tide monitoring and recording system in accordance with claim 1, characterized by being based on the use of monitoring and recording equipment of tides and the characteristics of ocean wave size and period, by indirectly measuring changes in the level of water around a pipe, the upper end of which is hermetically sealed and the lower end of which is submerged in the ocean, and its correlation to the measurement of the corresponding change in pressure inside the pipe.

3. Wave and tide monitoring and recording system in accordance with claim 1, characterized by the pressure signal transmitter (3) connected to the upper end of the pipe (1) having an electric signal output of between 4-20 mA.

4. Wave and tide monitoring and recording system in accordance with claim 1, characterized by a signal acquisition module (4) converts the electric signal between 4-20 mA into digital information, which is sent to a micro-processor (5) containing a dedicated software to monitor, record, and process these signals.

5. Wave and tide monitoring and recording system in accordance with claim 1, characterized by also insulating the pipe (1) in such a way as to avoid conducting thermal energy to correct the effect of heat on the air inside the pipe.

6. Wave and tide monitoring and recording system in accordance with claim 1, characterized by also providing temperature sensors installed in the equipment to correct the effect of heat on the inside of the pipe (1).
